(19) United States
(12) Patent Application Publication
(10) Pub. No.: US 2001/0011234 A1
(43) Pub. Date: Aug. 2, 2001

(54) System and method for transacting with graded prices by users based on a network

(75) Inventor: Ki Yeol Kim, Seoul (KR)

Correspondence Address: Ladas & Parry, 26 West 61st Street, New York, NY, 10023, US

(73) Assignee: E -NET CO., LTD

(21) Appl. No.: 09/767,631

(22) Filed: Jan. 23, 2001

(30) Foreign Application Priority Data
Jan. 29, 2000 (KR) 2000-4451

(51) Int. Cl. G06F 17/60

(52) U.S. Cl. 705/26

(57) ABSTRACT

System and method for transacting with graded prices by users based on a network are disclosed, which classify users who wishes to purchase goods through electronic commerce business sites into predetermined grades by predetermined criteria and provides graded prices information with respect to the same goods by classified grades.

The electronic commerce business server connected to client units according to users' intentions according to the present invention inputs log-in data transferred according to the manipulations of the users, determines users set groups or users grades by reading additional information built in a first database unit in use of the log-in data and using the read additional information, reads goods information and basic sales prices information of goods built in a database, determines final sales prices of the goods in predetermined prices determination rules with respect to the read sales prices information on the basis of the users set groups or the users grades, and transfers finally determined goods sales prices information, the basic sales prices information, and the goods information to the client units to be displayed on screens.

### BACKGROUND OF THE INVENTION

1. Field of the Invention

The present invention relates to system and method for transacting with graded prices by users based on a network, and more particularly to system and method for transacting with graded prices by users based on a network, which classify users who wishes to purchase goods through electronic commerce business sites into predetermined grades by predetermined criteria and provides graded prices information with respect to the same goods by classified grades.

2. Reference to Related Patents Applications

U.S. Pat. No. 6,144,727 Method and system for global telecommunications network management and display of market-price information

U.S. Pat. No. 6,076,070 Apparatus and method for on-line price comparison of competitor's goods and/or services over a computer network

U.S. Pat. No. 6,012,046 Crossing network utilizing satisfaction density profile with price discovery features

U.S. Pat. No. 5,845,266 Crossing network utilizing satisfaction density profile with price discovery feature

U.S. Pat. No. 5,761,442 Predictive neural network means and method for selecting a portfolio of securities wherein each network has been trained using data relating to a corresponding security

U.S. Pat. No. 5,689,652 Crossing network utilizing optimal mutual satisfaction density profile

3. Description of Related Arts

Recently, computers are explosively supplied, so that it is a trend that the world is connected to one network through the internet which is an area where users all over the world can share time and space.

Accordingly, a number of companies open their sites on the internet to conduct their publicity for their companies to netizens or users can provide their own information to others as well as easily find information they want through the internet.

That is, if a user launches a web browser installed in a computer for a connection to the internet and inputs a particular universal resource locator (URL), the web browser is connected to a server in which a corresponding site exists, and the user can use information of various kinds in the forms of text and graphics provided by the site.

As stated above, internet users all over the world can use the internet anywhere and anytime, without limits to time and space, and new sites having their own distinctiveness different from existing sites appear as the number of sites is rapidly increased.

Out of such sites, electronic commerce business sites, which enables users of diverse social classes to purchase various goods such as clothes, books, discs, and so on through the internet without facing the sellers, are rapidly increasing in lots of popularity of internet users.

At this time, in case that plural users use the electronic commerce business sites, since each user can view prices for respective goods such as various books, discs, and so on, in addition to the goods he or she wants by connecting to sites opened in the internet instead of directly visiting stores, the user directly chooses goods he or she wishes to purchase and filling out order forms of client information, charge settlement information, delivery information, and so on, by using the goods and prices.

That is, an electronic commerce business server has a separate database built for providing users of client personal computers (PC) with goods information and prices information corresponding to the goods, and the database stores predetermined discount rates with respect to respective goods which can be discounted on basically predetermined goods prices according to goods prices provided by goods suppliers.

However, the sales prices of goods determined in the above electronic commerce business is uniformly applied to all users connected to electronic commerce business servers, so the electronic commerce business servers in service up to date fail to present different prices to users who connect thereto.

### SUMMARY OF THE INVENTION

To solve the above problem, it is an object of the present invention to provide system and method for transacting with graded prices by users based on a network, which, in case that certain users connect to an electronic commerce business server in order to purchase goods through the internet, the electronic commerce business server builds a database with all produced additional information and manages the database, classifies the users connected to the electronic commerce business into predetermined grades according to predetermined criteria by using the users' additional information built in the database, and provides goods information in graded prices by classified grades to the users connected to the electronic commerce business server.

In order to achieve the above object, according to the present invention, in a system, in which, if client units are connected to an electronic commerce business server through a communication network, the electronic commerce business server transfers information of plural goods and prices information of the corresponding goods to client units and users who determine the purchase intentions by using the goods and prices information provided from the electronic commerce business server transfer purchase goods information to the electronic commerce business server through the client units in order for goods sales and purchases are transacted in sites, the electronic commerce business server determines users set groups including users by using log-in data inputted from the client units, determines final sale prices of the goods in price determination rules predetermined according to the users set group, and transfers the determined final sales prices information to the client units together with basic sales prices information and the goods information.

Further, in order to achieve the above object, the electronic commerce business server according to the present invention determines users grades including users by using log-in data inputted from the client units, determines final sale prices of the goods in price determination rules predetermined according to the users grades, and transfers the determined final sales prices information, basic sales prices information, and the goods information to the client units.

Furthermore, in order to achieve the above object, a method according to the present invention comprises steps of (1) inputting log-in data transferred according to the manipulations of the users, (2) determining users set groups or users grades by reading additional information built in a first database unit in use of the log-in data and using the read additional information, (3) reading goods information and basic sales prices information of goods built in the second database unit in case tht the log-in data is inputted, (4) determining final sales prices of the goods in predetermined prices determination rules with respect to the read basic sales prices information on the basis of the users set groups or the users grades, and (5) transferring the goods information to the client units together with finally determined goods sales prices information and the basic sales prices information to be displayed on screens.

### BRIEF DESCRIPTION OF THE DRAWINGS

The above object and other advantages of the present invention will become more apparent by describing in detail a preferred embodiment thereof with reference to the attached drawings, in which:

FIG. 1 is a view for explaining a system for transacting with graded prices by users based on a network according to an embodiment of the present invention;

FIG. 2 is a block diagram for schematically showing a structure of the electronic commerce business server applied in FIG. 1;

FIG. 3 is an illustrative view for explaining users sets applied to an embodiment of the present invention;

FIG. 4 is an illustrative view for explaining users grades applied to an embodiment of the present invention;

FIG. 5 is an illustrative view for explaining final sales prices determined according to an embodiment of the present invention; and

FIG. 6 is a view for explaining a method for transacting with graded prices by users based on a network according to an embodiment of the present invention.

### DETAILED DESCRIPTION OF THE PREFERRED EMBODIMENT

Hereinafter, a preferred embodiment of the present invention will be described in detail with reference to the accompanying drawings.

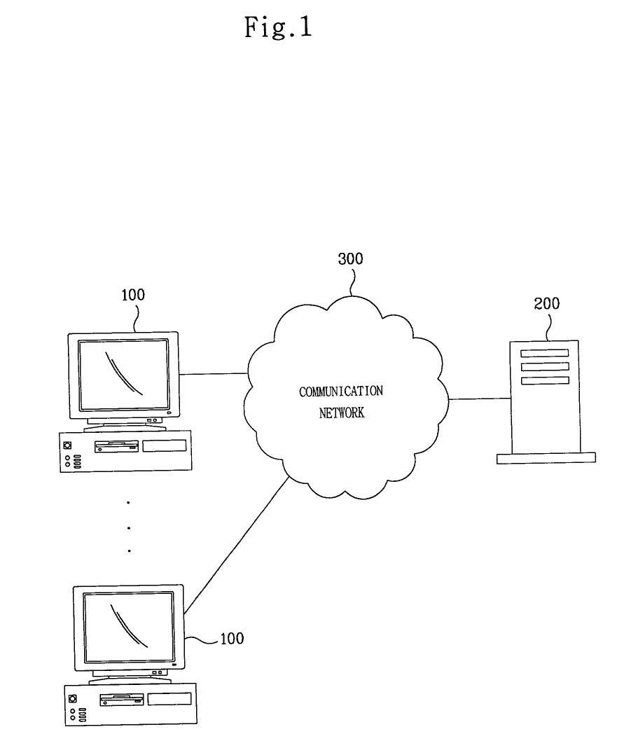

FIG. 1 is a view for explaining a system for transacting with graded prices by users based on a network according to an embodiment of the present invention.

As shown in FIG. 1, a client personal computer(PC) 100 according to a first embodiment of the present invention has a web browser installed to perform an electronic commerce transaction through a communication network 300, and, if an electronic commerce business server 200 described later is connected with the web server launched and an electronic commerce transaction is chosen by each user after a connection to the electronic commerce business server 200, outputs to the electronic commerce business server 200 log-in data inputted by each user according to certain data inputted from the electronic commerce business server 200, and, after the log-in of each user is executed, inputs goods information, basic sales prices information, and graded-by-users sales prices information provided from the electronic commerce business server 200 for a display on a screen after the log-in of each user is executed.

The electronic commerce business server 200 builds various goods information provided from plural goods suppliers and users' additional information in a separate database, judges whether users are authenticated through the log-in data that plural client personal computers (PCs) 100 connected through the communication network 300 input, reads the additional information built in the database by using the log-in, determines a users set group including the users by using the additional information, determines the final sales price of goods predetermined price determination rules according to the users set group, and transfers the determined final sales price to the client PCs 100 together with goods information.

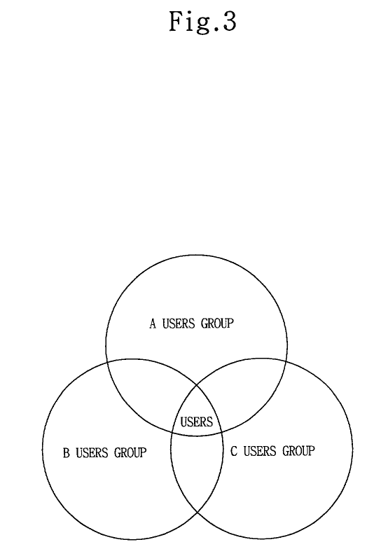

The users set group, as shown in FIG. 3, in case that plural pieces of the additional information built in the database are read, means a users group including all criteria additional information in which the read plural pieces of the additional information are predetermined.

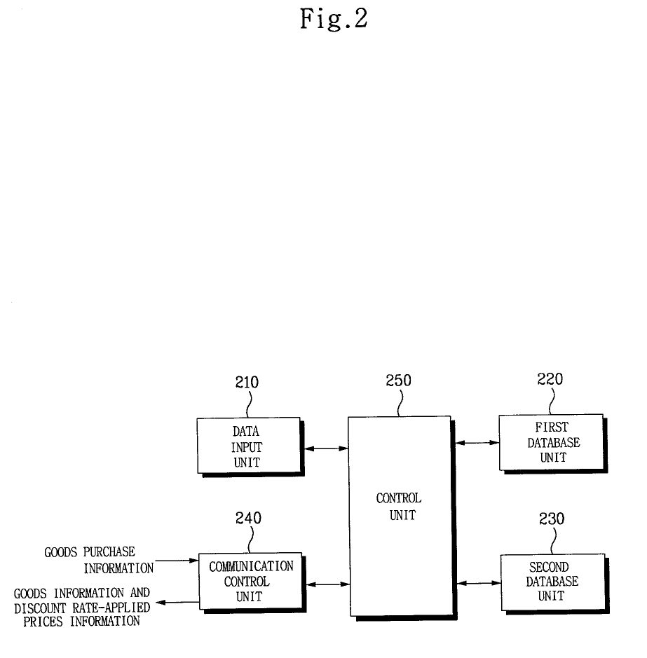

For example, in case that a set group A is a set of female customers of twenties whose purchase amounts are between two hundred thousand Won (Korean currency unit) and three hundred thousand Won and in case that a female at age of 23 whose purchase amount is two hundred and fifty thousand Won is found in the additional information read from a first database unit (refer to a reference numeral 220 in FIG. 2) by using a log-in data of a user, the user belongs to the set group A.

The communication network 300 connects communication lines between the undefined plural client PCs 100 and the electronic commerce business server 200, to thereby enable the electronic commerce business server 200 to sell certain goods provided from goods suppliers and users to purchase the goods.

FIG. 2 is a block diagram for schematically showing a structure of the electronic commerce business server applied in FIG. 1.

As shown in FIG. 2, a data input unit 210 receives an operation program related to the electronic commerce business by a server administrator, outputs it to a main control unit 250 described later, and outputs to a second database unit 230 the goods information and prices information provided from plural goods suppliers(not shown).

The first database unit 220 stores log-in data inputted by the users of the client PCs 100 and additional information of plural pieces produced in the process for the users to connect to the electronic commerce business server 200.

The additional information of plural pieces is continuously upgraded according to the controls of a control unit 250 whenever the users connect to the electronic commerce business server 200.

The second database unit 230 stores at least one or more goods information and prices information corresponding to the goods which are provided from the goods suppliers, and the goods information and the prices information are upgraded to goods information and prices information provided through the data input unit 210 according to the controls of the control unit 250.

A communication control unit 240 outputs an electronic commerce business program of applying graded goods prices by users to the users of the plural client PCs 100 connected through the communication network 300, outputs to the control unit 250 additional information according to the uses of the electronic commerce business of respective users, and outputs to the users of the client PCs 100 the goods information, the goods prices information applied in graded goods prices by users, and basic sales prices information.

The control unit 250 controls the additional information to be stored in the first database unit 220 by using identification information inputted through the communication control unit 240. In case that the identification information is inputted through the communication control unit 240, the control unit 250 determines a users set group including a user by reading the additional information stored in the first database unit 220, and, after determining the final sale prices according to the users set group by reading the basic sales prices information of the goods stored in the second database unit 230, transfers the corresponding good information to the client PCs through the communication control unit 240 together with the basic sales prices information.

Another embodiment of the present invention, when comparing to the above embodiment, in calculating the sales prices of the goods determined for applying a graded manner by users in the electronic commerce business server 200, is to substitute users grades for the users set group of the above embodiment with different criteria information.

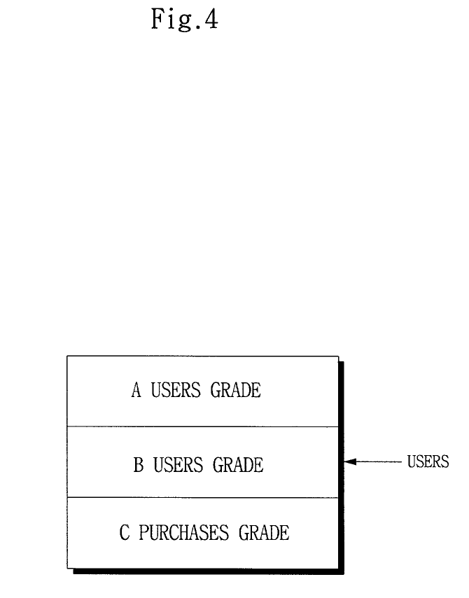

At this time, the users grades, as shown in FIG. 4, are the ranking determined according as plural pieces of additional information built in a database in the electronic commerce business server 200 are read, weights predetermined with respect to the respective plural pieces of additional information which are read are given, and the given weights are calculated.

Taking an instance for the users grades, the electronic commerce business server 200 defines that average weight values 9˜10 are referred to as special members, 7˜8.9 as superior members, and weights below 7 as general members.

Further, pieces of information for purchase amounts, refunds or non-refunds, board uses, the number of goods search times, and the company employees are chosen out of the plural pieces of additional information, and different weight units are applied to the chosen pieces of additional information by respective cases.

Under the state defined as above, an average weight value of a user becomes 7.6 in case that the user gets a weight of 2 with a purchase amount of over one hundred thousand Won, a weight of 10 with all purchased goods paid without refunds, a weight of 8 with posting more than twice a week on the board operated in the electronic commerce business server 200, a weight of 8 with the number of search times of the goods more than twice but no more than four times a week by connecting to the electronic commerce business server 200, so the user belongs to a superior member class.

Operations of a system for transacting with graded prices by users based on a network according to the present invention having a structure stated above will be described in more detail with reference to FIG. 1 to FIG. 6.

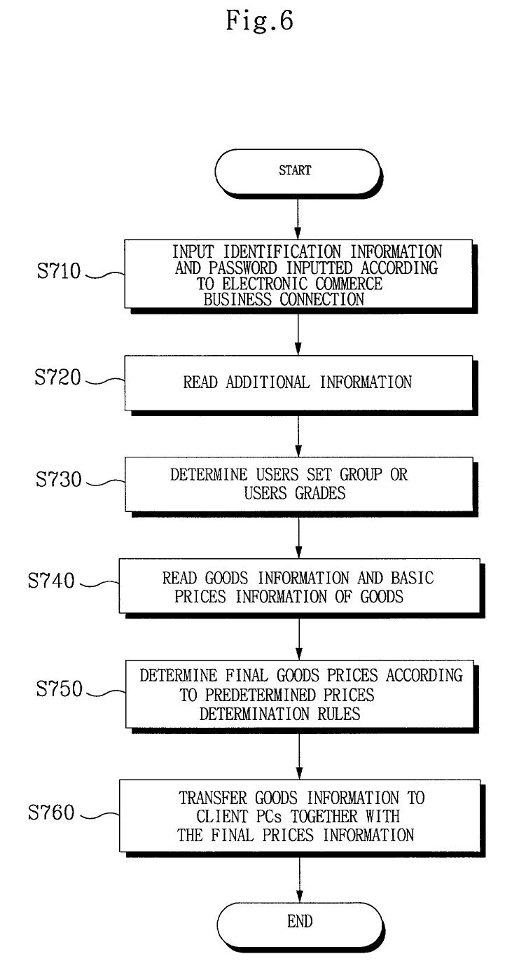

FIG. 6 is a view for explaining a method for transacting with graded prices by users based on a network according to an embodiment of the present invention.

As shown in FIG. 6, the electronic commerce business server 200 builds the electronic commerce business in order for plural users to purchase certain goods by receiving goods information and prices information corresponding to the goods information which are provided by plural goods suppliers.

That is, the electronic commerce business server 200 receives from plural goods suppliers the goods information and prices information to be on sale through the electronic commerce business, converts the corresponding goods information provided from the plural goods suppliers into a data format used in the electronic commerce business, and databases the data by classifying the data by kinds and companies according to the electronic commerce business program format to be provided to the respective users.

As stated above, after building the electronic commerce business to be transferred to the client PCs 100 by grading the goods prices by users in the electronic commerce business server 200, it is verified whether communication connections are made to the electronic commerce business server 200 by the users of the client PCs 100 through the communication network such as the internet and so on.

That is, if the communication connections are made to the electronic commerce business server 200 through the launching of web browsers installed in the respective client PCs 100, the electronic commerce business server 200 outputs user log-in screen data to the corresponding client PCs 100 in order for a log-in screen to be displayed on the screens of the client PCs 100.

Further, the plural client PCs 100 output to the electronic commerce business server 200 the log-in data of identification information and passwords inputted by respective users through the log-in screen displayed on the screens, and the electronic commerce business server 200 judges whether the users are the registered users or new users through the log-in data inputted by the users of the respective client PCs 100.

In case that the users of the client PCs 100 are the registered users, the electronic commerce business server 200 determine a users set group or a users grade by using the users log-in data, and outputs to the client PCs 100 the final sales prices determined by price determination rules predetermined on the basis of the users set groups or the users grades, basic sales prices, and the goods information corresponding to them, to thereby be displayed on the screens.

However, as a result of the above determination, in case of the new users, the electronic commerce business server 200 outputs certain member registration data and executes the member registrations of the new users through the data inputted by the respective users, and, if the new member registrations for the respective users are completed, the goods information and the basic sales prices information which the respective users can choose in the electronic commerce business program are outputted to the corresponding client PCs 100, to thereby be displayed on the screens (S710).

Accordingly, if the users of the client PCs 100 are connected to the electronic commerce business server 200 through a communication environment, the electronic commerce business server 200 reads the additional information built in the first database unit 220 by using the log-in data inputted by the users and determines the users set groups or the users grades by using the read additional information (S720).

Further, as stated above, in case that the log-in data is inputted, the electronic commerce business server 200 reads the goods information and the basic sales prices information of the goods which are built in the second database unit 230 (S730).

The electronic commerce business server determines the final sales prices of the goods with respect to the read basic sales prices information by the predetermined price determination rules on the basis of the users set groups or the users grades (S740).

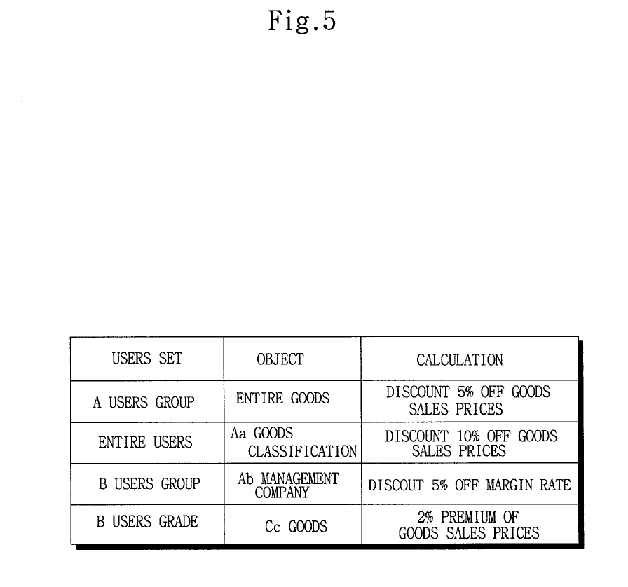

That is, the final sales prices of the goods provided through the electronic commerce business server 200 are determined in various manners as shown in FIG. 5.

Firstly, if a user connected to the electronic commerce business server 200 belongs to a set group A, amounts discounted 5% off the basic sales prices with respect to the entire goods built in the second database unit 230 become the final sales prices of the goods information to be provided to the client PCs 100.

Secondly, amounts 10% discounted off the goods sales prices with respect to the goods classified into particular items out of the goods built in the second database unit 230 for the entire users connected to the electronic commerce business server 200 become the final sales prices of the goods to be provided to the client PCs 100.

Thirdly, in case that a user connected to the electronic commerce business server 200 belongs to a set group B, the final sales prices are determined to have 5% margin rate with respect to the goods belonging to certain goods suppliers out of the goods built in the second database unit 230.

Fourthly, if a user connected to the electronic commerce business server 200 belongs to a users grade B and selects certain goods out of the goods built in the second database unit 230, amounts adding a 2% premium to the basic sales prices corresponding to the goods is determined as the final sales prices.

Taking an instance, in case that cosmetics are on sale for promotion to twenties' females during a particular period according to a marketing plan, the electronic commerce business server 200 is set beforehand for the particular period to be counted.

If the value to be counted is matched with the particular period set beforehand, the control unit 250 of the electronic commerce business server 200 determines the age range of a user by using the log-in data transferred to the electronic commerce business server 200 through the communication connection.

As a result of the determination, if a female at twenties is connected during the particular period set beforehand, goods information and prices information corresponding to it are provided in order for the female to purchase the particular goods set in advance in the electronic commerce business server 200 in prices discounted compared to the other users.

A calculation method for providing goods prices graded by users in the electronic commerce business server 200 can be easily obtained in diverse manners other than the manner stated above in case of those who work in the same field.

Therefore, by transferring the final sales prices information of the goods information determined as stated above to the client PCs 100 together with the basic sales prices information and the goods information to be displayed on the screen (S750), users can know their own credit degrees from the electronic commerce business server 200.

As stated above, with the system for transacting with graded prices by users based on a network according to the present invention, firstly, the effects are provided that goods sale persons secure good-quality purchasers at the same time with continuously maintaining sales/purchases relationships.

Secondly, the effects can be provided that the diversity of marketing plans can be devised and repetitive purchases and uses can be derived by defining the members grades, presenting the criteria of raising or lowering the grades according to the purchase amounts and use frequency, and providing more discounted prices to the purchasers.

Thirdly, the effects can be provided that it can be used for the compensation policy for employees or pre-paid members.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A system for transacting with graded prices by users based on a network, in which, if client units are connected to an electronic commerce business server through a communication network, the electronic commerce business server transfers information of plural goods and prices information of the corresponding goods to client units and users who determine the purchase intentions by using the goods and prices information provided from the electronic commerce business server transfer purchase goods information to the electronic commerce business server through the client units in order for goods sales and purchases are transacted in sites, characterized in that the electronic commerce business server determines users set groups including users by using log-in data inputted from the client units, determines final sale prices of the goods in price determination rules predetermined according to the users set group, and transfers the determined final sales prices information to the client units together with basic sales prices information and the goods information.

2. The system as claimed in claim 1, wherein the electronic commerce business server including:
a data input unit for inputting operating programs related to electronic commerce business, the goods information and the prices information provided to the client units by a server administrator;
a first database unit for storing the log-in data inputted by users of the client units and additional information produced upon executing the electronic commerce business in correspondence with the log-in data;
a second database unit for storing at least one or more goods information and prices information corresponding to the goods;
a communication control unit for receiving the log-in data and the additional information inputted by the users of the client units and transferring to the client units the goods information and the prices information corresponding to the goods provided from the electronic commerce business server; and
a control unit for controlling to store the additional information in the first database unit by using the log-in data inputted through the communication control unit, determining the users set group including the users by reading the additional information stored in the first database unit in case that the log-in data is inputted through the communication control unit, and, after determining final sales prices according to the users set group by reading basic sales prices information of the goods stored in the second database unit, transferring the corresponding basic sales prices information to the client units through the communication control unit together with the goods information.

3. The system as claimed in claim 1, wherein the electronic commerce business server classifies the goods to be provided to the client units by kinds, suppliers, or particular goods to be associated with graded users set groups, to thereby determine the final sales prices of the goods.

4. The system as claimed in claim 2, wherein the electronic commerce business server classifies the goods to be provided to the client units by kinds, suppliers, or particular goods to be associated with graded users set groups, to thereby determine the final sales prices of the goods.

5. The system as claimed in claim 1, wherein the users set groups are sets of groups that, by reading plural additional information built in the databases, the read plural additional information includes all of predetermined criteria additional information.

6. The system as claimed in claim 2, wherein the users set groups are sets of groups that, by reading plural additional information built in the databases, the read plural additional information includes all of predetermined criteria additional information.

7. The system as claimed in claim 3, wherein the users set groups are sets of groups that, by reading plural additional information built in the databases, the read plural additional information includes all of predetermined criteria additional information.

8. The system as claimed in claim 4, wherein the users set groups are sets of groups that, by reading plural additional information built in the databases, the read plural additional information includes all of predetermined criteria additional information.

9. The system for transacting with graded prices by users based on a network, in which, if client units are connected to an electronic commerce business server through a communication network, the electronic commerce business server transfers information of plural goods and basic sales prices information of the corresponding goods to client units and users who determine the purchase intentions by using the goods and basic sales prices information provided from the electronic commerce business server transfer purchase goods information to the electronic commerce business server through the client units in order for goods sales and purchases are transacted in sites, characterized in that the electronic commerce business server determines users grades including users by using log-in data inputted from the client units, determines final sale prices of the goods in price determination rules predetermined according to the users grades, and transfers the determined final sales prices information, basic sales prices information, and the goods information to the client units.

10. The system as claimed in claim 9, wherein the electronic commerce business server including:
a data input unit for inputting operating programs related to electronic commerce business, the goods information and the prices information provided to the client units by a server administrator;
a first database unit for storing the log-in data inputted by users of the client units and additional information produced upon executing the electronic commerce business in correspondence with the log-in data;
a second database unit for storing at least one or more goods information and prices information corresponding to the goods;
a communication control unit for receiving the log-in data and the additional information inputted by the users of the client units and transferring to the client units the goods information and the prices information corresponding to the goods provided from the electronic commerce business server; and
a control unit for controlling to store the additional information in the first database unit by using the log-in data inputted through the communication control unit, determining the users set group including the users by reading the additional information stored in the first database unit in case that the log-in data is inputted through the communication control unit, and, after determining final sales prices according to the users set group by reading basic sales prices information of the goods stored in the second database unit, transferring the corresponding basic sales prices information to the client units through the communication control unit together with the goods information.

11. The system as claimed in claim 9, wherein the additional information is information produced from at least one of goods searches, purchase goods selections, and goods purchases of the users which are provided in the electronic commerce business server and information of verifying employees.

12. The system as claimed in claim 10, wherein the additional information is information produced from at least one of goods searches, purchase goods selections, and goods purchases of the users which are provided in the electronic commerce business server and information of verifying employees.

13. The system as claimed in claim 9, wherein the electronic commerce business server classifies the goods to be provided to the client units by kinds, suppliers, or particular goods to be associated with graded users set groups, to thereby determine the final sales prices of the goods.

14. The system as claimed in claim 9, wherein the users grades are ranks determined by calculating given weights when reading plural additional information built in databases of the electronic commerce business server and giving predetermined weights to the respective read plural additional information.

15. The system as claimed in claim 10, wherein the users grades are ranks determined by calculating given weights when reading plural additional information built in databases of the electronic commerce business server and giving predetermined weights to the respective read plural additional information.

16. The system as claimed in claim 11, wherein the users grades are ranks determined by calculating given weights when reading plural additional information built in databases of the electronic commerce business server and giving predetermined weights to the respective read plural additional information.

17. The system as claimed in claim 12, wherein the users grades are ranks determined by calculating given weights when reading plural additional information built in databases of the electronic commerce business server and giving predetermined weights to the respective read plural additional information.

18. The system as claimed in claim 13, wherein the users grades are ranks determined by calculating given weights when reading plural additional information built in databases of the electronic commerce business server and giving predetermined weights to the respective read plural additional information.

19. A method for transacting with graded prices by users based on a network, having an electronic commerce business server connected to client units according to users' intentions comprising steps of:
(1) inputting log-in data transferred according to the manipulations of the users;
(2) determining users set groups or users grades by reading additional information built in a first database unit in use of the log-in data and using the read additional information;
(3) reading goods information and basic sales prices information of goods built in the second database unit in case tht the log-in data is inputted;
(4) determining final sales prices of the goods in predetermined prices determination rules with respect to the read basic sales prices information on the basis of the users set groups or the users grades; and
(5) transferring the goods information to the client units together with finally determined goods sales prices information and the basic sales prices information to be displayed on screens.

20. The method as claimed in claim 19, wherein the additional information read in the step (2) is information produced from at least one of goods searches, purchase goods selections, and goods purchases of the users which are provided in the electronic commerce business server and information of verifying employees.

21. The method as claimed in claim 19, wherein the final sales prices of the goods determined in the step (4) is discounted or at a premium from the basic sales prices based on goods kinds, suppliers, or particular goods provided from the electronic commerce business server to the users.

22. The method as claimed in claim 19, wherein the users set groups are sets of groups that, by reading plural additional information built in the databases, the read plural additional information includes all of predetermined criteria additional information, and the users grades are ranks determined by calculating given weights when reading plural additional information built in databases of the electronic commerce business server and giving predetermined weights to the respective read plural additional information.

23. The method as claimed in claim 20, wherein the users set groups are sets of groups that, by reading plural additional information built in the databases, the read plural additional information includes all of predetermined criteria additional information, and the users grades are ranks determined by calculating given weights when reading plural additional information built in databases of the electronic commerce business server and giving predetermined weights to the respective read plural additional information.

24. The method as claimed in claim 21, wherein the users set groups are sets of groups that, by reading plural additional information built in the databases, the read plural additional information includes all of predetermined criteria additional information, and the users grades are ranks determined by calculating given weights when reading plural additional information built in databases of the electronic commerce business server and giving predetermined weights to the respective read plural additional information.
